(19) United States
(12) Patent Application Publication
(10) Pub. No.: US 2010/0228690 A1
(43) Pub. Date: Sep. 9, 2010

(54) CUSHION ASSEMBLY

(75) Inventor: BARUCH NAEH, TEL AVIV (IL)

Correspondence Address: DEBORAH A. GADOR, P.O. BOX 4133, GANEL TIKVA, 55900, IL

(73) Assignee: BARUCH NAEH CREATIVE BRANDING LTD, TEL AVIV (IL)

(21) Appl. No.: 12/716,313

(22) Filed: Mar. 3, 2010

Related U.S. Application Data
(60) Provisional application No. 61/156,893, filed on Mar. 3, 2009.

(51) Int. Cl. A47C 16/00; G09F 7/00; G06Q 90/00

(52) U.S. Cl. 705/500; 5/653; 40/584

(57) ABSTRACT

A portable cushion assembly including a cushion, and a pouch pivotally coupled to the cushion, wherein the pouch is pivoted away from the cushion to permit sitting on the cushion without sitting on the pouch. Preferably, the cushion has an outer surface on which advertising material can be displayed. At least one strap may be affixed to the cushion or to the pouch for carrying the cushion assembly.

### RELATED APPLICATIONS

This application claims the benefit of U.S. provisional patent application No. 61/156,893 filed 3 Mar. 2009.

### FIELD OF THE INVENTION

This invention relates to a cushion, in general, and, in particular, to a portable cushion.

### BACKGROUND OF THE INVENTION

Portable cushions for carrying over the shoulder are known in the art. Some of these cushions have been used to display advertising.

U.S. Pat. No. 5,718,010 discloses a pillow with advertising collar, which includes an elongated pillow having enlarged ends and a smaller diameter central portion with a generally cylindrical collar encircling the central portion and having printed indicia on an outward face thereof. The collar has a diameter greater than the central portion but less than the ends of the pillows, thereby retaining the collar in position on the pillow.

U.S. Pat. No. 4,309,784 discloses a pillow-display case for housing and displaying various objects such as mementos, collections of small items and the like is disclosed. The pillow is of conventional construction, and has a transparent flexible overlay sheet covering a substantial portion of, and attached at its peripheral edges to, at least one face of the pillow. The space thus created between the transparent sheet and the pillow's face constitutes a display pocket, with re-closable pocket access means provided for introducing, arranging and removing the objects to be displayed. Advertising by means of the case is not disclosed.

U.S. Pat. No. 5,548,858 discloses a low cost disposable sleeping bag for use on a bed or cot or other support. The sleeping bag includes opposing single sheets of non-woven, soft paper forming an envelope, an apron for writing messages, keeping records, locating advertisements or playable amusement games or other desirable information, and an attached pillow case. The sleeping bag provides a comfortable confined sleeping area with a pillow for the user and prevents the user from coming in bodily contact with the bed, cot or support and provides information relevant to the user.

A combination of pillow and bag was disclosed in U.S. Pat. No. 6,988,286, teaching a cushioning apparatus, such as a pillow, which includes an upper pocket with reception cavity for receiving preferably loose or grouped non-integral filler material such as down, fiberfill or fiber-balls and another pocket for receiving additional filler material such as a foam core filler material.

The pillow also preferably includes a lower pocket joined about its periphery to the upper pocket such as by way of an intermediate gusset panel with beading and with the lower pocket also receiving loose or non-integrated filler material and with the bottom surface of the core preferably having a convex surface such as one symmetrical with the top surface.

None of the cushions described above provides an integral unit wherein a user can carry personal items together with the cushion. Accordingly, there is a long felt need for a cushion permitting a user to carry personal items together with the cushion in a fashion permitting sitting comfortably on the cushion while maintaining convenient access to the personal items.

### SUMMARY OF THE INVENTION

The present invention relates to a portable cushion assembly which includes an integrated pouch pivotally coupled to the cushion, which permits a user to carry personal items, such as a wallet or a snack or writing utensils or fan memorabilia, when the cushion is being carried, and which can be pivoted away from the cushion to permit sitting on the cushion without sitting on the pouch. For purposes of the present invention, the term “pouch” as used herein refers also to any appropriate bag, purse, pack, etc., that can be pivotally coupled to the cushion, and preferably includes a closure element, such as a drawstring or a zipper.

Preferably, the cushion assembly further includes at least one strap coupled to the cushion adapted and configured for transporting the cushion. In particular, the cushion assembly may includes two straps, for being supported on or wrapped around the user's shoulders, so the cushion can be carried like a backpack.

According to some embodiments of the invention, the cushion has an outer surface on which advertising material can be displayed. In fact, the entire cushion can be shaped to resemble a well known object, such as a soda or beer bottle cap, which, itself, can be used to advertise a product or sports team, etc.

There is also provided, according to the present invention, a method for forming a cushion assembly, the method including forming a cushion and pivotally coupling a pouch to the cushion portion, whereby the pouch can be pivoted away from the cushion to permit sitting on the cushion without sitting on the pouch.

### BRIEF DESCRIPTION OF THE DRAWINGS

The objects and advantages of various embodiments of the invention will become apparent from the following description when read in conjunction with the accompanying drawings wherein:

FIGS. 1a, 1b, 1c and 1d are rear, front, side and strapped views, respectively, of a portable cushion assembly constructed and operative in accordance with one embodiment of the invention;

FIG. 2 is a perspective view of the cushion assembly according to FIG. 1a ready for sitting;

FIG. 3 is a perspective view of a portable cushion assembly constructed and operative in accordance with another embodiment of the invention in a carrying orientation;

FIGS. 4a, 4b and 4c are front, side and rear perspective views, respectively, of a portable cushion assembly constructed and operative in accordance with a further embodiment of the invention;

FIG. 5a is a portable cushion assembly constructed and operative in accordance with yet another embodiment of the invention;

FIG. 5b is an assembled view of the portable cushion assembly of FIG. 5a;

FIGS. 6a and 6b are front perspective and side views, respectively, of the cushion of FIG. 5a;

FIGS. 7a, 7b and 7c are front perspective, rear and side views, respectively, of a portable cushion assembly constructed and operative in accordance with an alternative embodiment of the invention; and

FIG. 8 is a rear view of a portable cushion assembly constructed and operative in accordance with an embodiment of the invention for use in advertising; and

FIGS. 9a and 9b are rear and front views of a covered cushion assembly.

### DETAILED DESCRIPTION OF THE EMBODIMENTS

The present invention relates to a portable cushion assembly including a cushion, preferably a seat cushion, although a back cushion is also envisioned, and a pouch pivotally coupled to the cushion. The integrated pouch permits a user to carry personal items, such as a wallet or a snack or writing utensils or fan memorabilia with the cushion, as a single unit. The pouch has two orientations: a first orientation folded against or inside the cushion for ease of carrying or transportation, and a second orientation, pivoted away from the cushion, to permit the user to sit comfortably on the cushion without sitting on the pouch, while retaining convenient access to the contents of the pouch.

Preferably, the cushion assembly also includes at least one strap coupled to the cushion adapted and configured for carrying or transporting the cushion. The strap may be a handle for carrying in the hand of the user. It may, alternatively, be a single strap for wrapping around one shoulder of the user, for carrying on the side or on the back of the user. Or the cushion assembly may include two straps coupled to the cushion and positioned for engagement by the shoulders of a user, so the cushion can be carried on his or her back, like a backpack.

As will be described in detail below, the pouch can be pivotally coupled to the cushion in any number of ways. The pouch can be pivotally coupled to an outside surface of the cushion. The pouch can sit in a zippered pocket inside the cushion and be pivoted outside of the pocket to hang outside for sitting. The pouch may seat in a recess in the cushion when carried, to provide a comfortable fit on the back and so as not to squeeze items in the pouch. Or, it can be releasably affixed to the cushion for removal, for example, for laundering.

It will be appreciated that the outer surface of the cushion may be utilized to display graphic advertising.

The following description is provided so as to enable any person skilled in the art to make use of the invention and sets forth the best modes contemplated by the inventor of carrying out his invention. Various modifications, however, will remain apparent to those skilled in the art.

The term “cushion” herein refers to any type of pad or pillow used for sitting or kneeling on or leaning against, for example a sheet of polyurethane or sponge, a mat of padded wood, or a soft bag of some ornamental material, stuffed with wool, hair, feathers, polyester staple fiber, non-woven material, or even paper torn into fragments. It may be used for sitting or kneeling upon, or to soften the hardness or angularity of a chair, bench, stone or couch. The cushion may be configured to fit comfortably in stadium seats or amphitheater benches. Alternatively, the cushion can be used as a head cushion or seat for picnics, outdoor hiking, at the beach, etc.

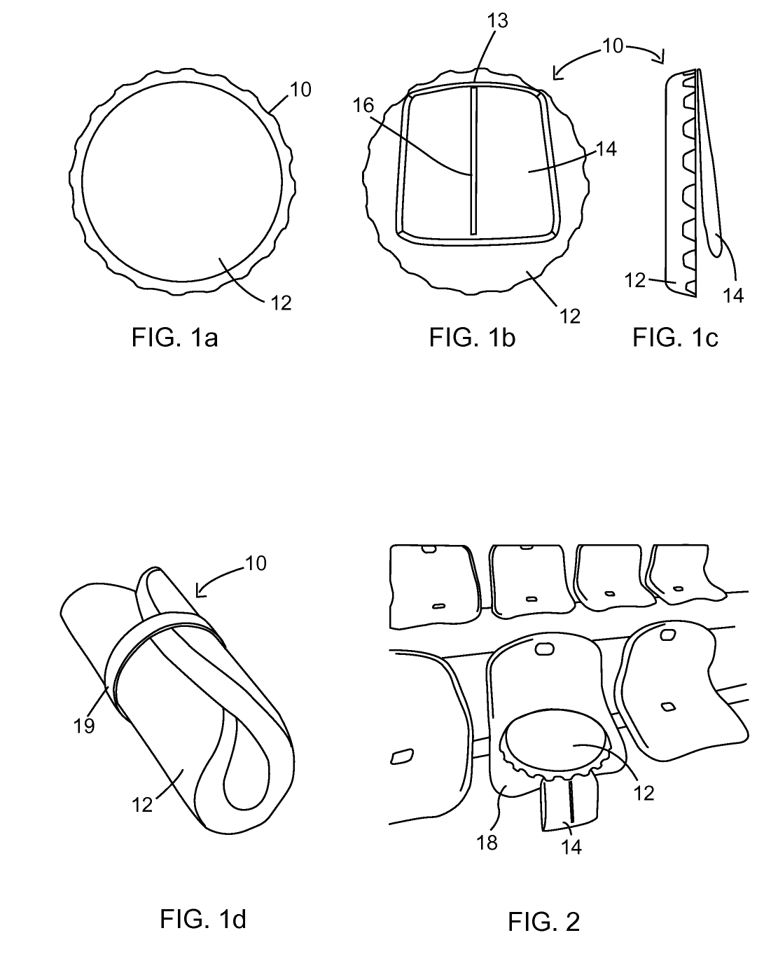

FIGS. 1a, 1b and 1c are rear, front and side views, respectively, of a portable cushion assembly 10 constructed and operative in accordance with one embodiment of the invention. Cushion assembly 10 includes a cushion 12 and a pouch 14 pivotally coupled to cushion 12. In this embodiment, pouch 14 is pivotally affixed to a portion of the outside, front surface of cushion 12, at the periphery 13, by means of any suitable attaching means. At least a portion of the attaching means may be selected from a group consisting of texturized surface, projections, protrusions, salients, bulges, straps, electrically chargeable surface useful to base static electrical potential, magnets, screws, hooks, zips, fasteners, clips, flaps, claspers, springs, grips, hooks-and-loops (especially Velcro™-type fasteners), hooks, hooks and eyes, straps, strings, wires, cables, tabs, links, poppers, nails, buttons, brackets, buckles, glueable means, or a combination thereof.

Pouch 14 may include a zipper 16 or any other opening means to permit a user to open the pouch in order to insert or remove personal objects. As described in detail below, the cushion 12 can be shaped in any desired fashion and can be formed of any suitable material. For example, a particularly long-lasting cushion can be formed of polyurethane, and a cloth or fabric bag or pouch can be attached thereto. Alternatively, the cushion can be at least partially made of materials selected from a group consisting of polymers, especially PET, melamine, polyamines, especially nylons, cardboards, metals, fabrics or any combination thereof.

The portable cushion of this embodiment can simply be folded or rolled and secured with a tie or belt 19 for carrying, as shown, by way of non-limiting example only, in FIG. 1d.

One exemplary use of portable cushion assembly 10 is illustrated in FIG. 2. When it is desired to sit on the cushion, pouch 14 is pivoted away from cushion 12 and the cushion 12 can be placed on the seat of a stadium chair 18 with the pouch hanging in front of chair 18. In this way, the user can sit comfortably on cushion 12 without sitting on pouch 14. At the same time, the user has convenient access to the pouch and its contents, for easy insertion and removal.

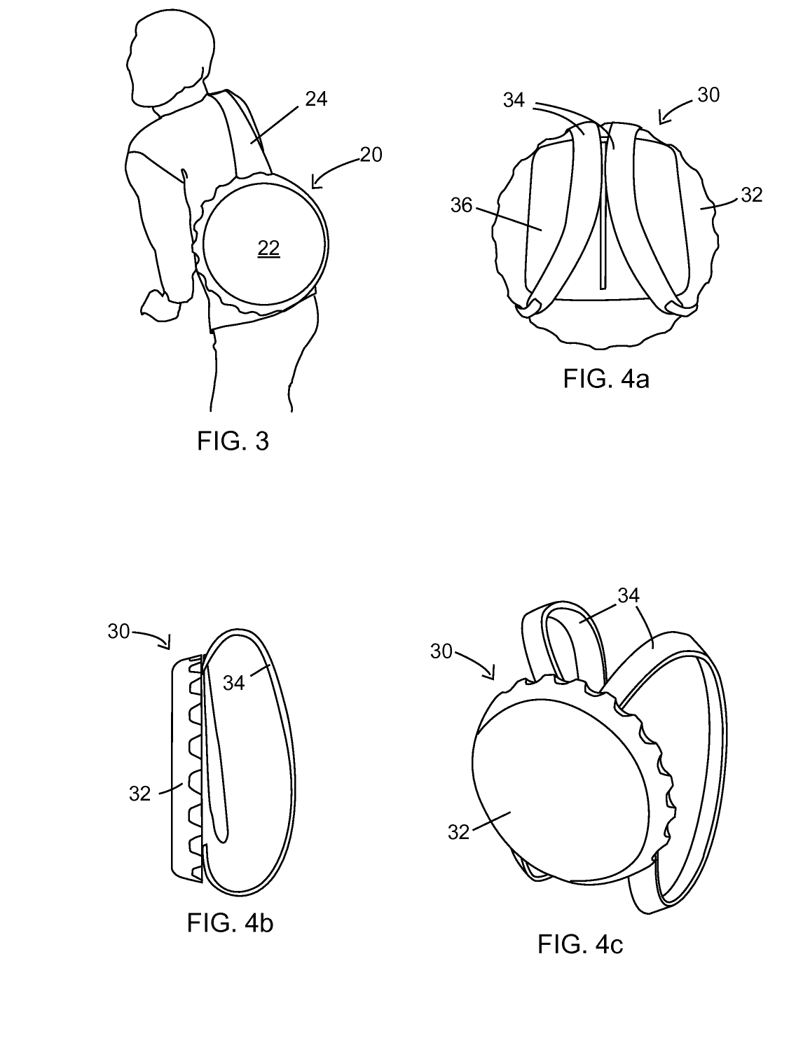

FIG. 3 is a perspective view of a portable cushion assembly 20 constructed and operative in accordance with another embodiment of the invention in a carrying orientation. In this embodiment, a single carrying strap 24 is provided, coupled to opposite edges of the cushion 22, to permit carrying of the cushion over one shoulder or across one shoulder and the opposite hip of the user.

FIGS. 4a, 4b and 4c are front, side and rear perspective views, respectively, of a portable cushion assembly 30 constructed and operative in accordance with a further embodiment of the invention. In this embodiment, a pair of straps 34 is affixed to the cushion 32 for engaging both shoulders of a user. In this way, the cushion can be carried on the back of the user, like a conventional backpack. In this embodiment, a pouch 36 is affixed to the cushion 32. When sitting or leaning on the cushion assembly, the straps can be folded out to the sides of the cushion, or can be tucked under the cushion or under the bottom of the seat, and the pouch can then pivot away from the cushion for reclining upon the cushion.

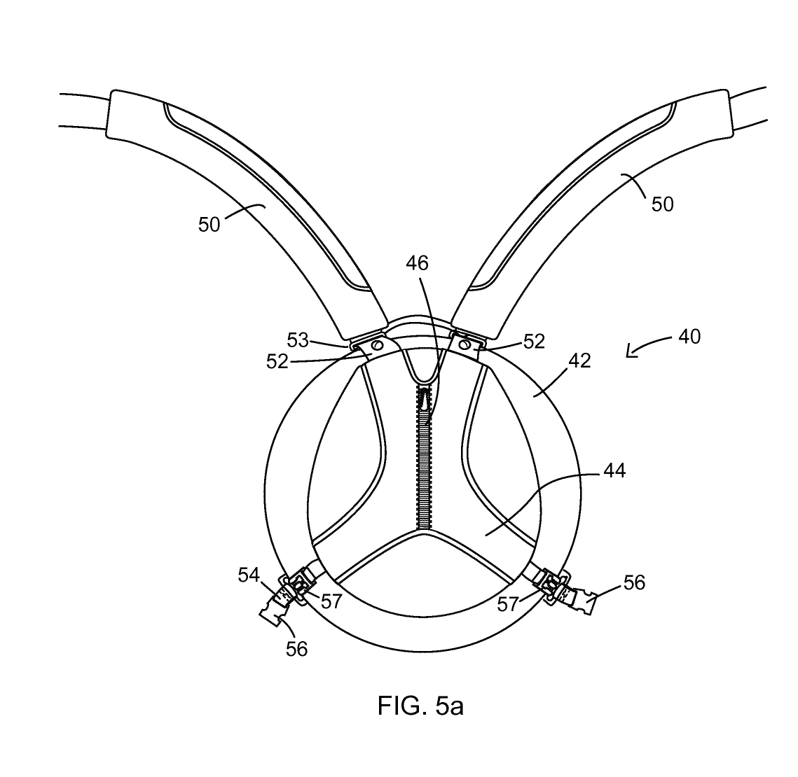

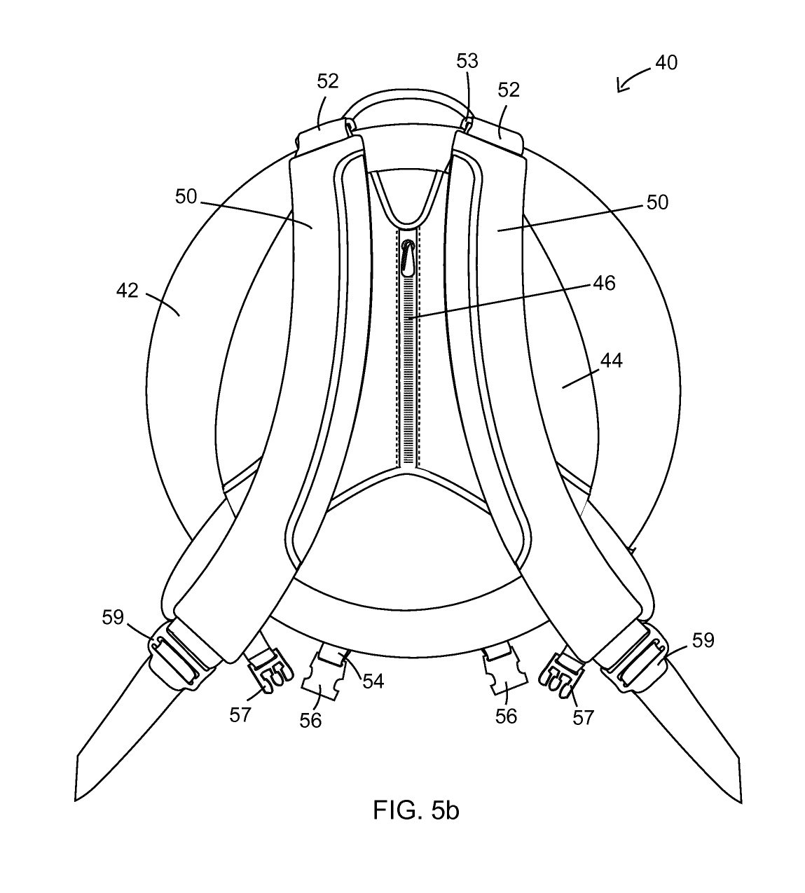

FIGS. 5a and 5b are front views of a portable cushion assembly 40 constructed and operative in accordance with yet another embodiment of the invention, in respective sitting and carrying orientations. Portable cushion assembly 40 includes a cushion 42, here shown as being of flexible material, such as a stuffed fabric. A pouch 44 having a zipper opening 46 is pivotally coupled to one side of cushion 42. Pouch 44 may be formed of any desired textile material, here shown as foam covered with a spandex material, such as Lycra®. Air mesh or other decorative fabric can be utilized to create a desired design.

As can be seen, in this embodiment, two straps 50 are affixed via top pivotal webbing 52 to pouch 44. Pouch 44 is coupled via top pivotal webbing 52 to cushion 42 for pivotal motion. This coupling may be permanent, as via lugs 53, or may be releasable, as by hook and loop fasteners, such as Velcro®. Buckle portions 56 are releasably affixed adjacent the opposite (bottom) side of cushion 42 by means of bottom webbing 54. Complementary buckle portions 57 are affixed to the bottom of pouch 44 to permit releasable engagement of the bottom of the pouch by the bottom of the cushion. The free ends of the straps 50 are engaged by means of functional or side release buckles 57, which are arranged to releasably lockingly engage straps 50, as known in conventional backpacks.

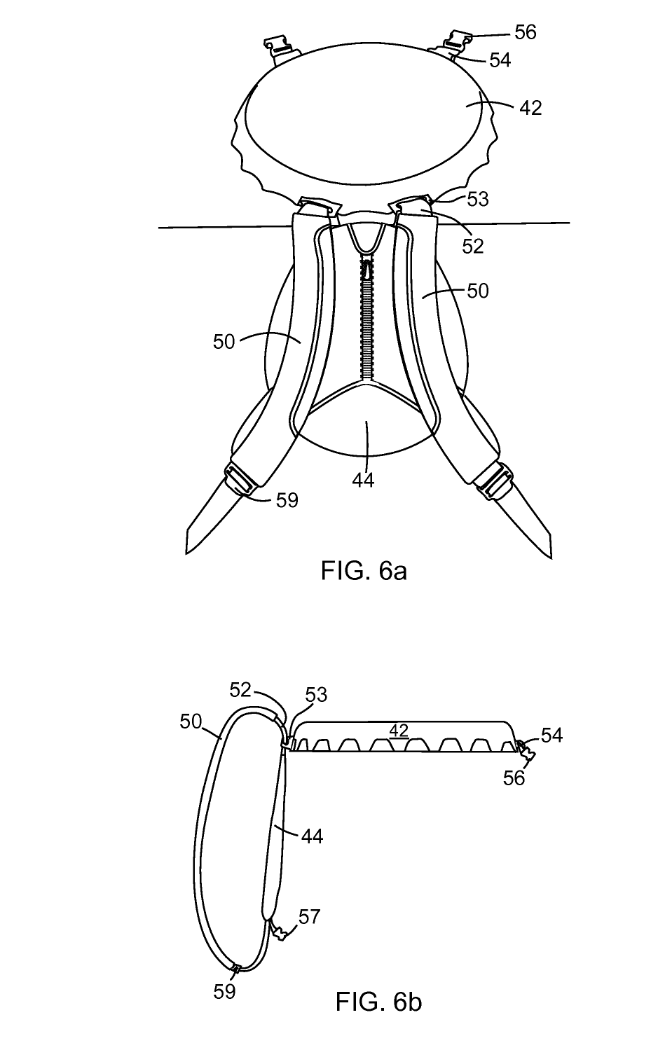

One exemplary use of portable cushion assembly 40 is illustrated in FIGS. 6a and 6b. When it is desired to sit on the cushion, one side of pouch 44 is released from the cushion 42 by opening buckles 56 and 57, and the pouch is pivoted away from cushion 42. Now the cushion 42 can be placed on the seat of a stadium chair, bench or other location with the straps and the pouch hanging in front of the seat or to the side of the cushion, if laid flat on the ground.

It will be appreciated that the cushion of the cushion assembly can be a multilayer cushion. The term “multilayer” herein refers to a cushion, integrated cushion-backpack assembly, etc., comprising, in a non-limiting manner, at least two layers. It is another object of the present invention to provide an integrated cushion-backpack assembly comprising a multilayer cushion and a backpack, the integrated cushion-backpack comprising N layers, N is an integer number equal or greater than 2, wherein the integrated cushion-backpack is characterized by at least one advertisement displayed on at least one portion of its surfaces.

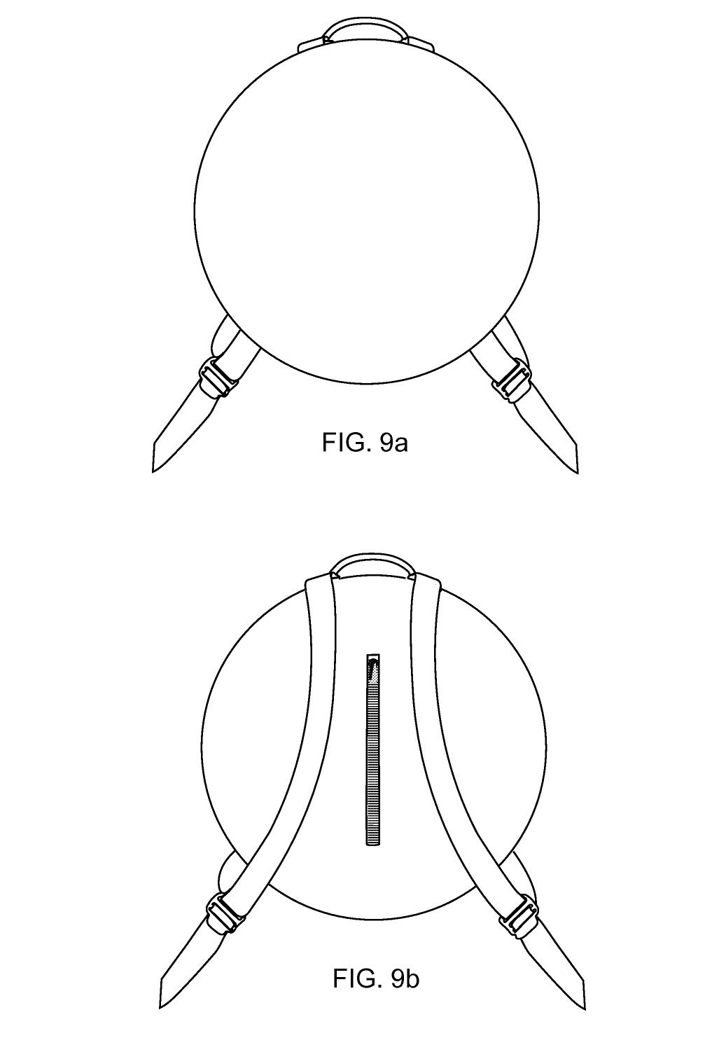

According to one embodiment of the invention, at least two layers are separated and different from each other by means of e.g., shape, size, composition, color, texture, etc. Hence, for example, and still in a non-limiting manner, at least one first layer is a puffy or flexible layer, and at least one second layer is a somewhat non-flexible, skin-like membrane, sheet, type of a coating. The outermost layer may serve as enveloping means adapted to clothe at least a portion of the cushion with a cover, as shown, for example, in FIG. 9. In this case, the cover layer can be removed and replaced by one of a plurality of covering layers can be provided, each having a different decoration or advertisement thereon.

According to other embodiments of the invention, the physical characteristics of the first and second layers are similar or approximately similar. Thus, a multilayer cushion may include two or more skin-like layers. According to another embodiment of the invention, the first layer is a physical layer, such as a rubber-like sheet, and the second layer is an advertisement in the form of a sticker, painted or printed graphics, located at the external side of the multilayer cushion. The multilayer cushion may include an external layer that is at least partially transparent. In such a case, a decorative design or advertisement can be coated by a transparent layer to reduce wear and protect the design.

Utilization of a multilayer cushion may provide improved orthopedic and ergonomic characteristics. Moreover, the multilayer structure of the cushion can be utilized to provide an article of manufacture with an enhanced quality. For example, the provision of a skin or membrane stretched over a puffy foam layer renders a luxuriant feel and texture to the multilayer cushion. If desired, the straps can also be anatomically designed to provide comfort during carrying.

Furthermore, the enhanced perception of comfort increases the ergonomic value of the item, while the reduced discomfort is beneficial to orthopedically challenged patients. It is well acknowledged in the literature that Lumbar patients are particularly sensitive to subtle dis-configuration of the cushion upon which they are resting. The discomfort thus induces such patients to frequently change their position in order to gain momentary relief which, in fact, stresses their spinal structure even more. The multilayer cushion provides stable conformity with the chair surface whilst the succeeding layers of the multilayer cushion mold and snugly fit the contour of the patient's posterior. The multilayer cushion provides sufficient comfortable configuration in congruence with the contours of the back as to minimize the minor compensatory adjustments and movements that such patient would otherwise perform.

It will be appreciated that the cushion assemblies of the present invention may be configured to adjust, by means of size and shape, the back and/or seat portion of a chair, so as to provide a more comfortable seat for the user. If desired, the cushion assembly may further include at least one immobilizing means adapted to at least reversibly affix the cushion to a carrying chair or other support or to one or more of the handles of the chair. The immobilizing means may be selected from a group consisting of texturized surface, projections, protrusions, salients, bulges, starps, electrically chargeable surface useful to base static electrical potential, magnets, screws, hooks, zips, fasteners, clips, flaps, claspers, springs, grips, hooks-and-loops, especially Velcro™-type fasteners, hooks, hooks and eyes, straps, strings, wires, cables, tabs, links, poppers, nails, buttons, brackets, buckles or any combination thereof, adhesive, or a combination thereof.

Thus, for example, the cushion 42 of the cushion assembly of FIG. 5a can be a multilayer cushion formed of at least two layers, an outer fabric layer (e.g., spandex and/or air mesh) and an inner stuffing layer or layers, e.g., foam. A zipper (not shown) may be provided in the outer fabric layer to permit removal from the inner stuffing layer, for laundering or replacement of the stuffing layer/s.

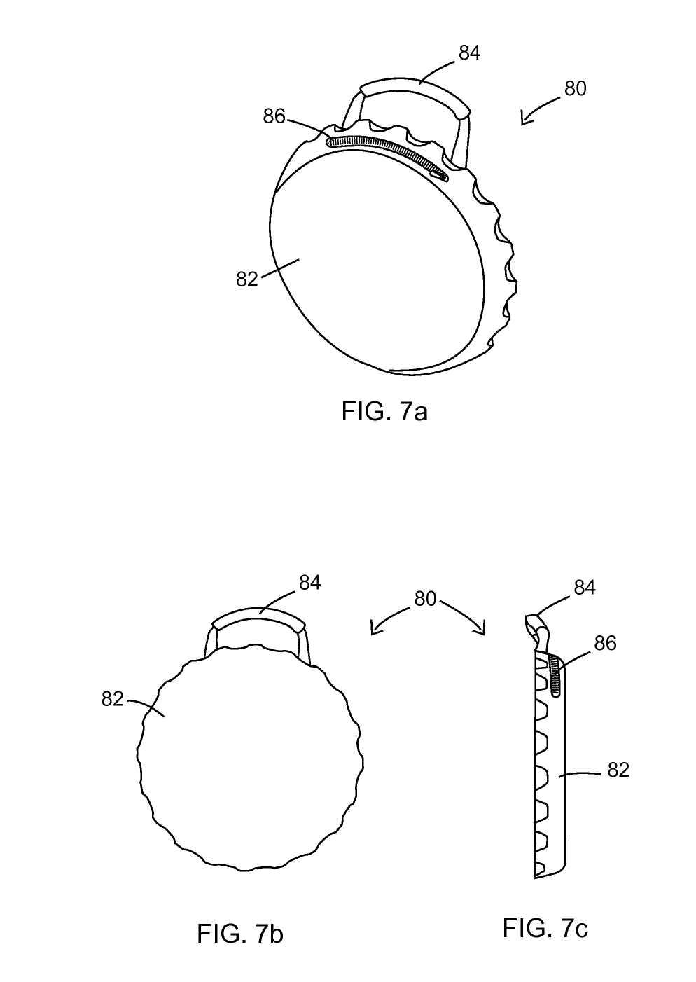

FIGS. 7a, 7b and 7c are rear perspective, front and side views, respectively, of a portable cushion assembly 80 constructed and operative in accordance with an alternative embodiment of the invention. Cushion assembly 80 includes a cushion 82 and a carrying handle 84 affixed to the periphery at one side of cushion 82. In this embodiment, a pouch (not shown) is pivotally mounted in a recess inside cushion 82 when the cushion is carried. The pouch may be closed inside the cushion 82 by any closure means 86, here illustrated as a zipper. When it is desired to sit on the cushion, the closure means is opened, and the pouch can be pivoted outside of the cushion.

According to some embodiments of the invention, the cushion has an outer surface on which advertising material can be displayed, which is visible at least when the cushion assembly is carried. In fact, the entire cushion can be shaped to resemble a well known object, such as a soda or beer bottle cap or crown, which, itself, can be used to advertise a product or sports team, etc. The term “advertising” herein refers to a paid, one-way communication through a medium in which the sponsor is identified and the message is controlled by the sponsor. Variations include publicity, public relations, product placement, sponsorship, underwriting, and sales promotion. It is well in the scope of the invention wherein the term “advertising” also refers, still in a non-limiting manner, to a display presented, and the display is of one or more of the following: educational, artistic, graphic, ethic, functional, etc. hence for example, the term merely refers to an artistic presentation, provided by drawings, graphs, color assembly, gray scale colors assembly, composition of colors and textures, and so on and so forth.

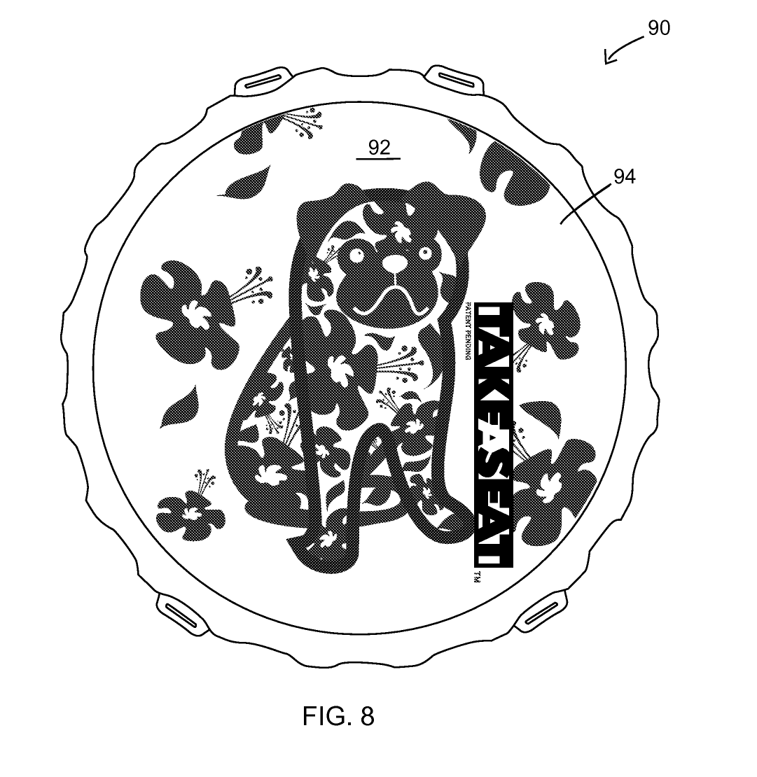

FIG. 8 is a rear view of a portable cushion assembly 90 constructed and operative in accordance with one embodiment of the invention as used for advertising. In this embodiment, the rear surface 92 (the portion facing outwards when the cushion is on a user's back) of the cushion 94 holds a graphic advertisement. The advertisement can be printed on the surface, as by silk printing, it can be a label which is affixed to the surface, as with adhesive, it can be a separately prepared layer that is press fit onto the cushion, it can be on an internal layer of the cushion which is coated with a transparent coating, or it can be disposed on the cushion in any other manner. For example, two outer layers of the cushion can define a pocket, and advertising material can be inserted into the pocket. Alternatively, or in addition, the cushion can be shaped in the form of an object which can, itself, be used as an advertisement. In the illustrated embodiment, the cushion is shaped like a crown or bottle cap, which can have the name of the soft drink company (or of any sponsor) advertised thereon. When a plurality of cushions are placed on seats in a stadium, the advertisements face upwards and can be seen from above, as well as from across the stadium.

Accordingly, it will be appreciated that the cushion assemblies of the present invention provide a novel means of advertisement. A plurality of cushion assemblies according to the invention, characterized by at least one graphic advertisement displayed on at least one portion of their surfaces and a pouch pivotally coupled to the cushion, are disposed on seats or benches at a place of a public event, and the pouch is pivoted away from the cushion to permit sitting on the cushion without sitting on the pouch.

Alternatively, the method may include offering the plurality of cushion assemblies to spectators to be used as the spectator's seat and to display the advertisement to spectators.

The cushion assemblies may be releasably affixed in place at the place of a public event using attaching means. The attaching means can be selected from a group consisting of a texturized surface, projections, protrusions, salients, bulges, straps, electrically chargeable surface useful to base static electrical potential, magnets, screws, hooks, zips, fasteners, clips, flaps, claspers, springs, grips, hooks-and-loops (especially Velcro™-type fasteners), hooks, hooks and eyes, straps, strings, wires, cables, tabs, links, poppers, nails, buttons, brackets, buckles, glueable means, or a combination thereof, although any suitable releasable attachment means can be utilized.

It will be appreciated that the cushions also serve as a form of advertising when the cushion is a carried by means of the strap or straps, since the graphic advertisement is visible when the cushion is transported.

While the invention has been described with respect to a limited number of embodiments, it will be appreciated that many variations, modifications and other applications of the invention may be made. It will further be appreciated that the invention is not limited to what has been described hereinabove merely by way of example Rather, the invention is limited solely by the claims which follow.

1. A portable cushion assembly comprising:
a cushion; and
a pouch pivotally coupled to the cushion;
wherein said pouch can be pivoted away from the cushion to permit sitting on the cushion without sitting on the pouch.

2. The cushion assembly according to claim 1, further comprising:
at least one strap coupled to said cushion, adapted and configured for transporting the cushion assembly.

3. The cushion assembly according to claim 1, further comprising:
at least one strap coupled to said pouch adapted and configured for transporting the cushion assembly.

4. The cushion assembly according to claim 1, wherein the cushion includes an outer surface on which advertising material can be displayed.

5. The cushion assembly according to claim 2, wherein the cushion comprises an outer surface on which advertising material can be displayed.

6. The cushion assembly according to claim 1, further comprising two straps coupled to said cushion, each positioned to be supported on a shoulder, for carrying the cushion assembly as a backpack.

7. The cushion assembly according to claim 1, wherein said cushion is a multilayer cushion.

8. The cushion assembly according to claim 1, wherein said pouch is pivotally coupled to a periphery of said cushion.

9. The cushion assembly according to claim 1, wherein said cushion is shaped to resemble a well known object.

10. The cushion assembly according to claim 1, wherein said pouch is pivotally mounted in a recess in said cushion and arranged to be pivoted outside said cushion for sitting.

11. The cushion assembly according to claim 4, wherein said outer surface is a removable layer of advertising material.

12. A method of advertising comprising:
providing at least one cushion assembly including:
a cushion having an outer surface; and
a pouch pivotally coupled to the cushion; and
displaying a graphic advertisement on at least a portion of said outer surface of said cushion.

13. The method according to claim 12, further comprising:
pivoting said pouch away from said cushion; and
disposing said cushion assembly on a seat so that said graphic advertisement on said outer surface of the cushion is visible.

14. The method according to claim 12, further comprising affixing at least one strap to said cushion for transporting the cushion, whereby said graphic advertisement is visible when said cushion is transported.

15. A portable cushion assembly comprising:
a cushion including including an outer surface on which a graphic advertisement is displayed;
two straps coupled to said cushion, each positioned to be supported on a shoulder, for carrying the cushion assembly as a backpack.

16. The portable cushion assembly according to claim 15, wherein said outer surface is a removable and replaceable cover.
